(19) United States
(12) Patent Application Publication
(10) Pub. No.: US 2008/0307479 A1
(43) Pub. Date: Dec. 11, 2008

(54) Bandwidth-Efficient Deployment of Video-On-Demand Assets in an IPTV Network

(75) Inventors: Emanuele Jones, Mariano Comense (CO) (IT); Mike Brehm, Allen, TX (US); Jason Brown, Frisco, TX (US)

Correspondence Address: Law Office of WILLIAM J. TUCKER, 2631 Lakeforest Ct., Dallas, TX, 75214, US

(73) Assignee: ALCATEL LUCENT, Paris (FR)

(21) Appl. No.: 12/049,014

(22) Filed: Mar. 14, 2008

Related U.S. Application Data
(60) Provisional application No. 60/943,161, filed on Jun. 11, 2007.

(51) Int. Cl. H04N 7/173

(52) U.S. Cl. 725/115; 725/87

(57) ABSTRACT

An IPTV network and a method are described herein that seamlessly integrate a multicast-based file transfer mechanism with unicast IPTV middleware to enable the efficient transfer of VOD assets from a Super Headend Office (SHO) to one or more Video Hub Offices (VHOs).

### CLAIM BENEFIT OF PRIOR FILED U.S. APPLICATION

This application claims the benefit of U.S. Provisional Patent Application Ser. No. 60/943,161 which was filed on Jun. 11, 2007 the contents of which are hereby incorporated by reference herein.

### TECHNICAL FIELD

The present invention is related to an IPTV network that seamlessly integrates a multicast-based file transfer mechanism with unicast IPTV middleware to enable the efficient transfer of Video-On-Demand (VOD) assets from a Super Headend Office (SHO) to one or more Video Hub Offices (VHOs).

### DESCRIPTION OF RELATED ART

The following abbreviations are herewith defined, at least some of which are referred to in the ensuing description of the prior art and the present invention.

### API Application Programming Interface

### BTV Broadcast Television

### CO Central Office

### DAS Direct Attached Storage

DNS Domain Name server

### DRM Digital Rights Management

### DSL Digital Subscriber Line

### DSLAM Digital Subscriber Line Access Multiplexer

### FQDN Fully-Qualified Domain Name

### HTTP HyperText Transfer Protocol

### HTTPS HyperText Transfer Protocol Secure

### IP Internet Protocol

### IPTV Internet Protocol Television

### OSS Operations Support System

### RGW Residential Gateway

### SAI Service Area Interface

### SHO Super Headend Office

### SMT Service Management Tool

### SSL Secure Sockets Layer

### STB Set-Top Box

### TV Television

### UDP User Datagram Protocol

### URI Uniform Resource Indicator

### VHO Video Hub Office

### VOD Video-On-Demand

Referring to FIG. 1 (PRIOR ART), there is a block diagram that illustrates the basic components of an exemplary IPTV network 100 which provides broadcast TV channels to homes via for example optical fiber or DSL phone lines. The exemplary IPTV network 100 shown includes two SHOs 102, a backbone network 104, multiple VHOs 106, multiple IOs 108, multiple COs 110, multiple SAIs 112 and multiple RGWs 114. In operation, each SHO 102 receives international/national TV feeds and supplies those international/national TV feeds via the backbone network 104 to each VHO 106. Then, each VHO 106 receives regional/local TV feeds and multicasts all of the TV feeds to their respective IOs 108. And, each IO 108 then multicasts all of the TV feeds to their respective COs 110. Then, each CO 110 multicasts all of the TV feeds to their respective SAIs 112. And, each SAI 112 then sends a few TV feeds out of all the possible TV feeds to their respective RGWs 114 which are associated with STBs 115. Thus, users can interface with their STB 115 and select one of the multicast TV channels to watch on their television set. If desired, the users can interface with their STB 115 and select a VOD to watch on their television set. The VOD feature and in particular how VOD assets (e.g., VOD titles) can be transported from each SHO 102 and deployed in their respective VHOs 106 is a main topic of the present discussion.

Referring to FIG. 2 (PRIOR ART), there is a diagram illustrating the basic components within the traditional SHO 102 and the traditional VHO 106 which has a bandwidth VOD asset deployment problem that will be addressed by the present invention. As shown, the traditional SHO 102 includes a VOD OSS/SMT server 202 and a VOD importer server 204. The traditional VHO 106 includes a branch management server 206, a branch controller 208, a branch database 210 and multiple VOD servers 212a and 212b (two shown). The SHO 102 and VHO 106 may include more components than the ones discussed herein but for clarity only the components associated with the present invention have been described herein.

In the current IPTV architecture, a VOD asset 214 (e.g., VOD title) is sent from a post-production house and received at the VOD importer server 204 in the SHO 102. The VOD importer server 204 places the VOD asset 214 in a staging volume 216 and applies encryption algorithms 218 (e.g., DRM keys 218) and makes custom metadata 220 modifications to the VOD asset 214. Once this is complete, the VOD asset 214 is ready for distribution to all of the VHOs 106 (only one has been shown). How this is done when the IPTV network 100 and in particular the SHO 102 and VHO 106 implement a unicast IPTV middleware 221 such as Microsoft's Mediaroom Middleware is described next.

The operator 222 interfaces (step 1a) with the branch management server 206 and instructs (step 1b) the branch controller 208 to make an HTTPS connection 224 with the VOD OSS/SMT server 202 in the SHO 102 (step 1c). The VOD OSS/SMT server 202 requests the file locations and status for the desired VOD asset 214 from the VOD importer server 204 (steps 1d and 1e). The collected data is returned back to the branch controller 208 and is stored in the branch database 210 (step 1f). Based on current usage statistics, the branch controller 208 then assigns a configurable number of VOD servers 212a and 212b to retrieve the VOD asset 214. Thereafter, the first VOD server 212a checks in with the branch controller 208 every 10 seconds (step 2a), at which time the branch controller 208 queries the branch database 210 to determine if a job exists for the VOD server 212a (step 2b). Since there is a job, the first VOD server 212a retrieves the VOD asset 214 from the VOD importer server 204 in the SHO 102 via a HTTPS connection 226 (steps 2c and 2d) and stores the VOD asset 214 on a connected DAS device 228 (step 2e). When this download is complete, the branch controller 208 contacts the VOD OSS/SMT server 202 in the SHO 102 via another HTTPS connection 230 to retrieve the DRM keys 218 (step 3a). The VOD OSS/SMT server 202 proxies (step 3b) the request to the VOD importer server 204 which performs a proper transcription (step 3c) based on the branch certificate's public key and returns the DRM keys 218. The branch controller 208 then stores the DRM keys 218 in the branch database 210 (step 3d). At this point in the transfer process, the remaining VOD server(s) 212b (only one shown) in the VHO 106 will be triggered to retrieve the VOD asset 214. Upon being triggered, the remaining VOD server(s) 212b check (step 4a) with the branch controller 208 but instead of retrieving the asset from the SHO 102, the remaining VOD server(s) 212b retrieve the VOD asset 214 from the first VOD server 212a (steps 4b and 4c). Then, the remaining VOD server(s) 212b store the VOD asset 214 in the media volume on their connected DAS device(s) 228 (step 4d).

In this scheme, the VHO 106 has one VOD server 212a which retrieves the VOD asset 214 using the HTTPS connection 226 from the VOD importer server 204 within the SHO 102. However, each VOD asset 214 is comprised of several large files which can be up to 2 GB in size that have to pass through the HTTPS connection 230. This is problematical since the bandwidth required for the transfer of this VOD asset 214 can be a bottleneck for deployment. This is especially true since each of the VHOs 106 in the IPTV network 100 has one VOD server 212a which retrieves the VOD asset 214 from their respective SHO 102 in this manner. Accordingly, there has been a need and still is a need for addressing this shortcoming and other shortcomings which cause bandwidth problems for IPTV networks that implement unicast IPTV middleware. This need and other needs have been satisfied by the present invention.

### SUMMARY

In one aspect, the present invention provides a method that seamlessly integrates a multicast-based file transfer mechanism with unicast IPTV middleware so as to be able to efficiently transfer VOD assets from a SHO to a VHO. In one embodiment, the method comprises the steps of: (a) using a multicast file transfer server associated with the SHO to multicast the VOD asset to one or more multicast file transfer clients in the VHO; (b) storing the VOD asset received by the one or more multicast file transfer clients within one or more multicast caches in the VHO; (c) accessing a unicast IPTV middleware in the VHO to initiate deployment of the VOD asset from the one or more multicast caches to one or more VOD servers within said VHO; (d) deploying the VOD asset using a HTTP connection from one multicast cache to the first VOD server within the VHO; and (e) instructing each of the remaining VOD servers if any within the VHO to retrieve the VOD asset from the first VOD server.

In another aspect, the present invention provides an IPTV network that seamlessly integrates a multicast-based file transfer mechanism with unicast IPTV middleware so as to be able to efficiently transfer VOD assets from a SHO to a VHO. In one embodiment, the SHO includes a multicast file transfer server that multicast a VOD asset to one or more multicast file transfer clients associated with the VHO. The VHO includes one or more multicast caches that store the VOD asset received by the one or more multicast file transfer clients. Plus, the VHO includes a branch management server with unicast IPTV middleware that initiates deployment of the VOD asset from the one or more multicast caches to one or more VOD servers in the VHO. In addition, the VHO includes a branch controller that uses a HTTP connection to deploy the VOD asset from one multicast cache to the first VOD server. Furthermore, the VHO includes the branch controller that instructs each of the remaining VOD servers if any to retrieve the VOD asset from the first VOD server.

Additional aspects of the invention will be set forth, in part, in the detailed description, figures and any claims which follow, and in part will be derived from the detailed description, or can be learned by practice of the invention. It is to be understood that both the foregoing general description and the following detailed description are exemplary and explanatory only and are not restrictive of the invention as disclosed.

### BRIEF DESCRIPTION OF THE DRAWINGS

A more complete understanding of the present invention may be obtained by reference to the following detailed description when taken in conjunction with the accompanying drawings wherein:

FIG. 1 (PRIOR ART) is a diagram of an exemplary IPTV network which has traditional SHOs and traditional VHOs that provide broadcast TV channels to homes via for example optical fiber or DSL phone lines;

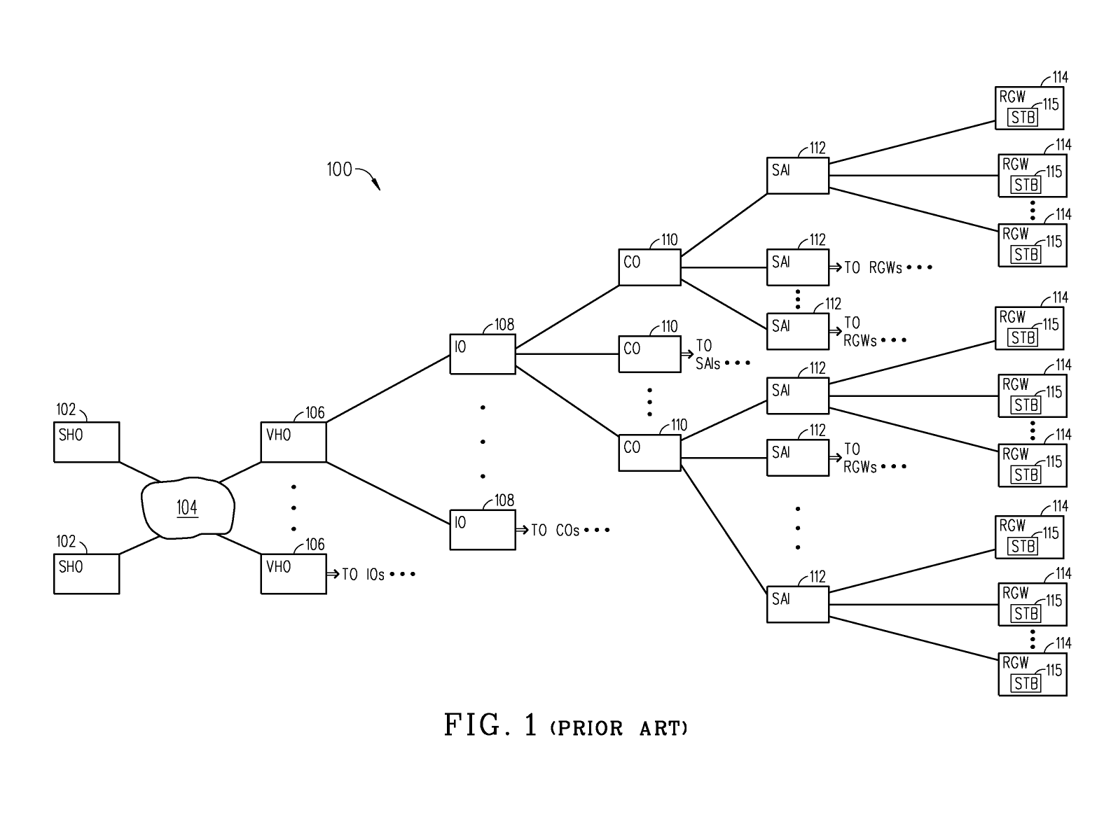

FIG. 2 (PRIOR ART) is a diagram of one of the traditional SHOs and one of the traditional VHOs shown in FIG. 1 which is used to help explain a VOD asset deployment bandwidth problem that is solved by the present invention;

FIG. 3 is a diagram of an exemplary IPTV network which has enhanced SHOs and enhanced VHOs in accordance with the present invention;

FIG. 4 is a diagram of one of the enhanced SHOs and one of the enhanced VHOs shown in FIG. 3 that addresses the aforementioned VOD asset deployment bandwidth problem in accordance with a first embodiment of the present invention; and

FIG. 5 is a diagram of one of the enhanced SHOs and one of the enhanced VHOs shown in FIG. 3 that addresses the aforementioned VOD asset deployment bandwidth problem in accordance with a second embodiment of the present invention.

### DETAILED DESCRIPTION

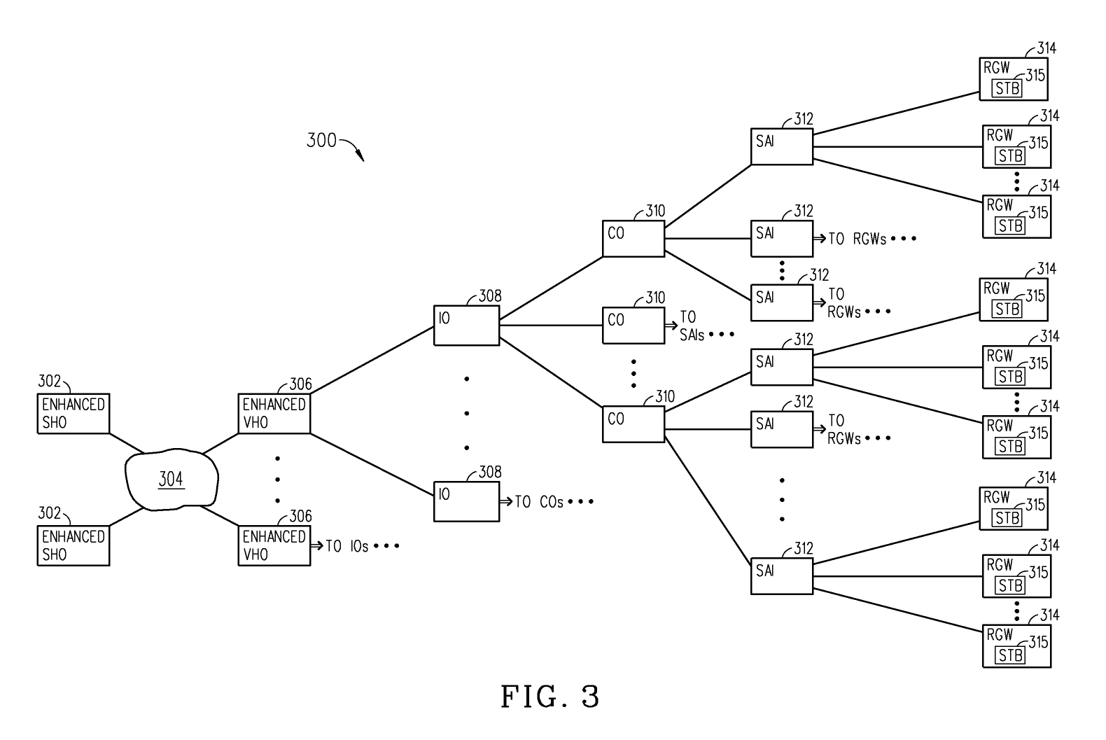

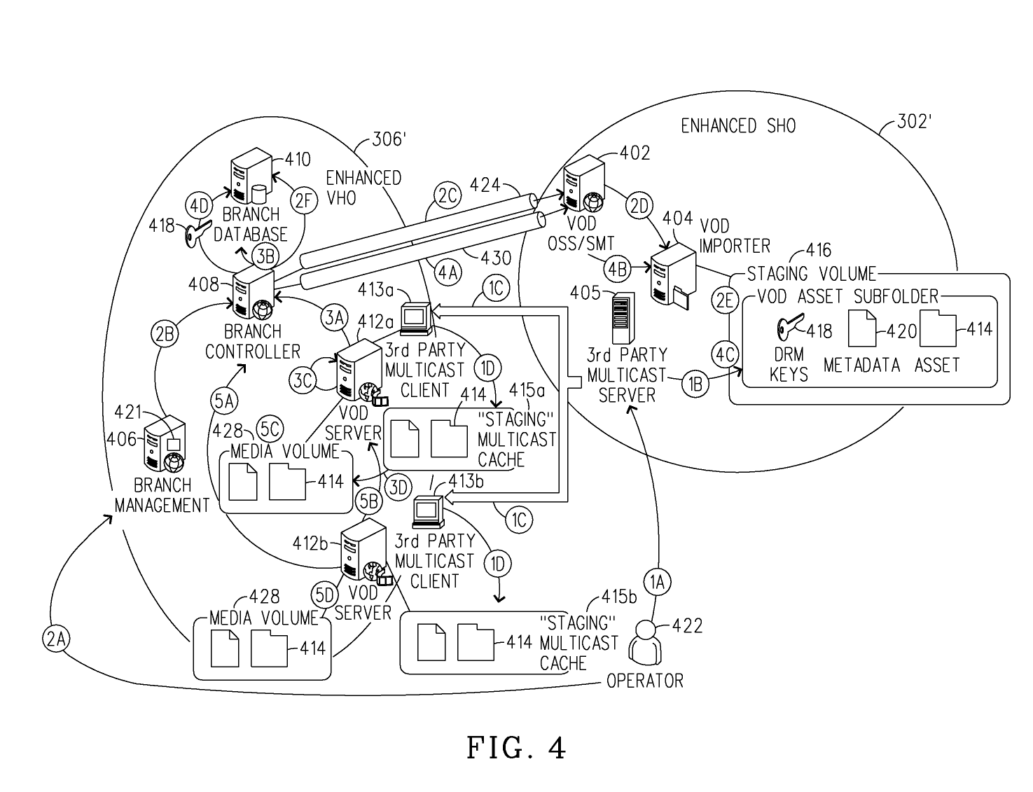

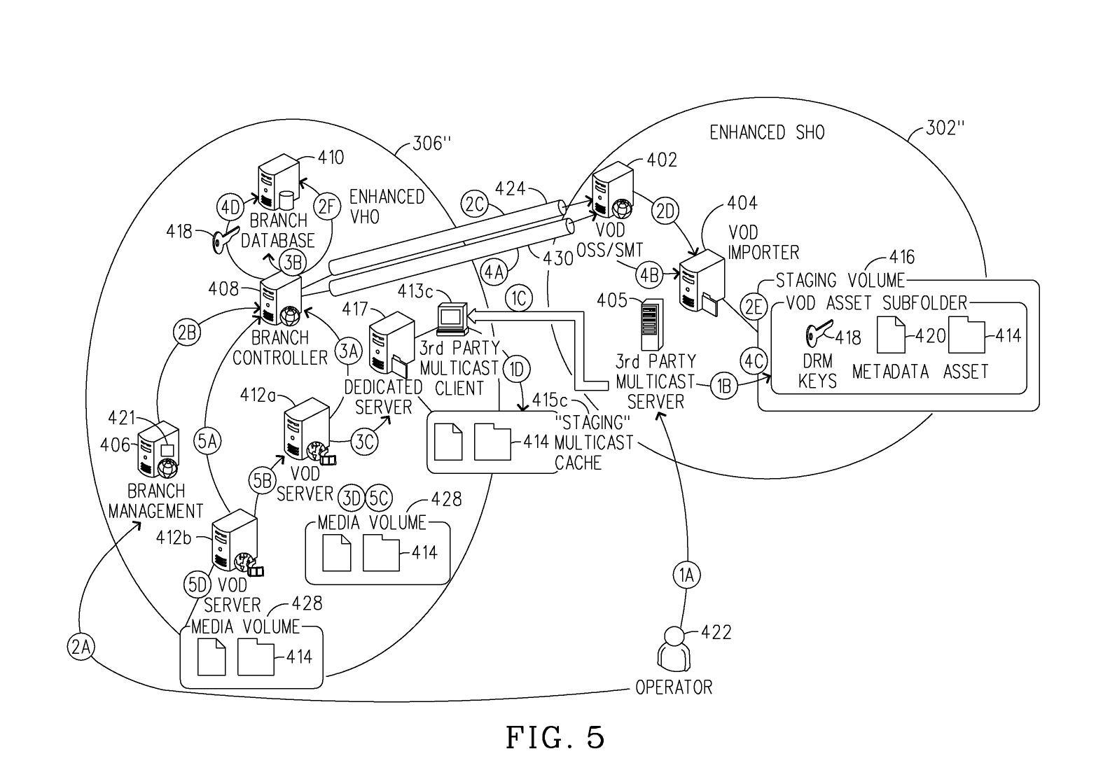

Referring to FIG. 3, there is a block diagram that illustrates the basic components of an exemplary IPTV network 300 which has enhanced SHOs 302 and enhanced VHOs 306 that together address the aforementioned bandwidth VOD asset deployment problem in accordance with the present invention. The exemplary IPTV network 300 shown includes two enhanced SHOs 302, a backbone network 304, two enhanced VHOs 306, multiple IOs 308, multiple COs 310, multiple SAIs 312 and multiple RGWs 314. In operation, each enhanced SHO 302 receives international/national TV feeds and supplies those international/national TV feeds via the backbone network 304 to each enhanced VHO 306. Then, each enhanced VHO 306 receives regional/local TV feeds and multicasts all of the TV feeds to their respective IOs 308. And, each IO 308 then multicasts all of the TV feeds to their respective COs 310. Then, each CO 310 multicasts all of the TV feeds to their respective SAIs 312. And, each SAI 312 then sends a few TV feeds out of all the possible TV feeds to their respective RGWs 314 which are associated with STBs 315. Thus, users can interface with their STB 315 and select one of the multicast TV channels to watch on their television set. If desired, the users can interface with their STB 315 and select a VOD to watch on their television set. The VOD feature and in particular how VOD assets (e.g., VOD titles) can be efficiently transported from the enhanced SHOs 302 and deployed in their respective enhanced VHOs 306 is discussed in detail below with respect to FIGS. 4-5.

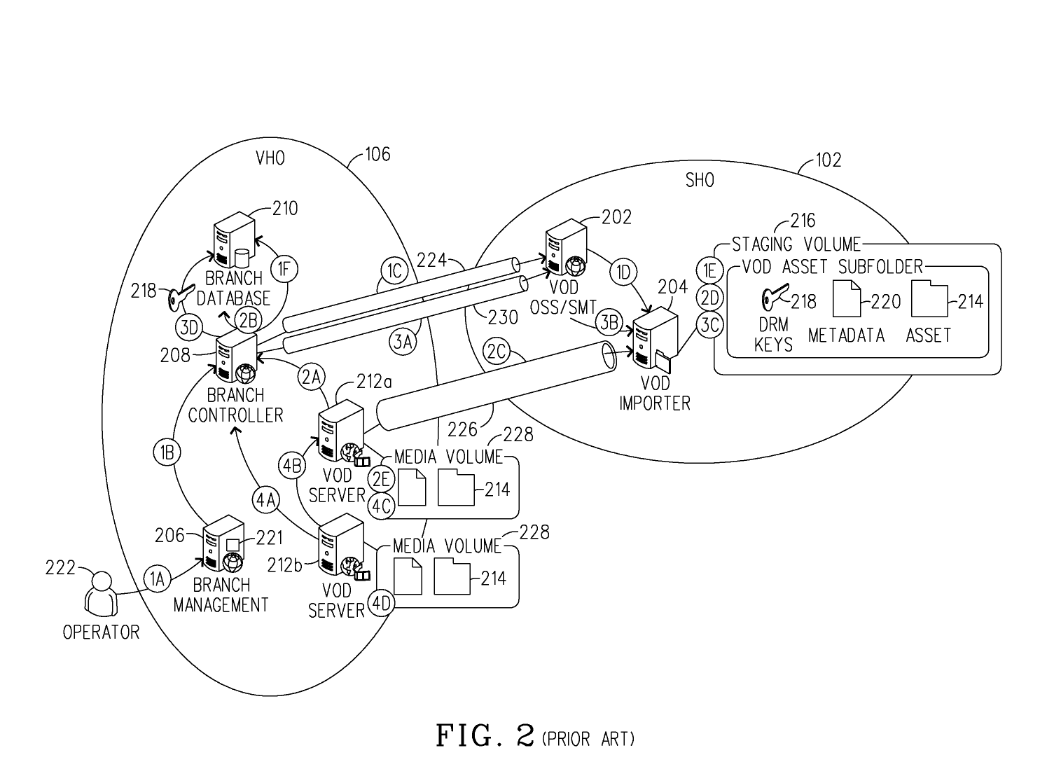

Referring to FIG. 4, there is a diagram illustrating the basic components within the enhanced SHO 302′ and the enhanced VHO 306′ shown in FIG. 3 in accordance with a first embodiment of the present invention. As shown, the enhanced SHO 302′ includes a VOD OSS/SMT server 402, a VOD importer server 404, and a third-party multicast file transfer server 405 (compare to FIG. 2). The enhanced VHO 306 includes a branch management server 406, a branch controller 408, a branch database 410, multiple VOD servers 412a and 412b (two shown), and third-party multicast file transfer clients 413a and 413b (compare to FIG. 2). The enhanced SHO 302′ and VHO 306′ may include more components than the ones discussed herein but for clarity only the components associated with the present invention have been described herein (note: the same is true for the enhanced SHO 302′ and the enhanced VHO 306′ which are discussed in detail below with respect to FIG. 5).

Basically, the present invention is related to seamlessly integrating the multicast file transfer server 405, the multicast file transfer clients 413a and 413b and the unicast-based IPTV middleware 421 (shown in the branch management server 406) by making a change as to how the VOD asset 414 is transported so as to be transparent to the unicast-based IPTV middleware 421. This seamless integration allows the bandwidth-efficient deployment tools associated with the multicast file transfer server 405 and the multicast file transfer client(s) 413a and 413b to efficiently transport VOD assets 414 from one or more SHOs 302′ to their respective VHO's 306′. A more detailed description about one way that this seamless integration can be implemented is provided after a brief discussion about the changes that should be made to the traditional architecture and traditional network flows of the SHOs and the VHOs.

First, a multicast file transfer product including the multicast file transfer server 405 and the multicast file transfer client(s) 413a and 413b should be selected or designed which can provide, for example, the following functionalities:
The multicast file transfer product 405, 413a and 413b should provide reliable multicast file transfer, meaning any lost packets should be retransmitted or recovered to ensure the file (e.g., VOD asset 414) is not corrupted or incomplete at the receivers (e.g., VHOs 306′).
The multicast file transfer product 405, 413a and 413b should provide/feedback about the state of the receivers (e.g., VHOs 306′) to allow the sender (e.g., SHO 302′) and, thus, the operator 422 to determine when all of the receivers (e.g., VHOs 306′) have successfully received the file (e.g., VOD asset 414).
The multicast file transfer product 405, 413a and 413b should provide multicast transfer since a multipoint transfer which creates unicast streams to the receivers (e.g., VHOs 306′) is not acceptable.

Several commercial off-the-shelf products such as, for example, the Stratacache OmniCast product satisfy these requirements.

Second, the IPTV servers 402, 404, 406, 408, 412a and 412b need to be configured to allow the multicast transfer to operate transparently to the unicast IPTV middleware 421. The following changes should be made:
The multicast file transfer server 405 needs to be installed in the SHO 302′ such that it has read access to the staging volume 416 in the VOD importer server 404. The staging volume 416 houses the encrypted VOD assets 414 which will be deployed to the VHO 306′ during VOD deployments. Assuming Microsoft's Mediaroom Middleware is being utilized, the multicast file transfer server 405 could be installed on the VOD importer server 304 itself, if the multicast file transfer server 405 selected is compatible with Windows server 2003.
A local “multicast cache” volume 415a and 415b needs to be created on each VOD server 412a and 412b in the VHO 306′ if the multicast file transfer clients 413a and 413b are installed directly on the VOD servers 412a and 412b. The local “multicast cache” volume 415a and 415b can physically reside on the local hard drives or be a subsection of a mounted disk array. The local “multicast cache” volume 415a and 415b should be shared via IIS as a virtual directory, with the appropriate security permissions applied. This share is named “staging” to match the “staging” volume name in the local cache volume 416 of the VOD importer server 404 within the SHO 302′. The size of the multicast cache volume 415a and 415b determines how many VOD assets 414 can be in-flight at any given time, so they should be configured based on the expected VOD deployment operational profile. Also, some consideration should be taken into account to allow for the expected larger file sizes associated with future high-definition (HD) VOD assets. In another embodiment, the multicast file transfer client 413 can be installed on a separate/dedicated server and not the VOD servers 412a and 412b. This embodiment is discussed below with respect to FIG. 5.
A pruning job should be used to remove any files older than a configurable date/time to prevent the local “multicast cache” volume 415a and 415b from growing too large.
The software associated with the multicast file transfer client 413a and 413b needs be installed in the VHO 306′ so that it has write access to the multicast cache volume 415a and 415b. Assuming Microsoft's Mediaroom Middleware is being utilized, the multicast file transfer client software 413a and 413b could be installed directly on the VOD servers 412a and 412b if the software is compatible with Windows server 2003.
The VOD importer server 404 in the SHO 302′ needs to be updated to use HTTP transfers instead of HTTPS to access the “staging” virtual directory in the staging volume 416 of the VOD importer server 404. Thus, the HTTPS connection 230 (SSL tunnel) used in the prior art will no longer be necessary, as the VOD servers 412a and 412b in the VHO 306′ will no longer directly contact the VOD importer server 404 for deployments of VOD assets 414 (a more detailed discussion about this aspect is provided below).
The hosts file (e.g., located in C:\WINDOWS\system32\drivers\etc\) needs to be updated on each VOD server 412a and 412b to translate the fully-qualified domain name (FQDN) of the VOD importer server 404 in the SHO 302 to the corresponding VOD server's local loopback IP address of 127.0.0.1 (for example) if they have the multicast file transfer client 413a and 413b installed thereon (a more detailed discussion about this aspect is provided below). Alternatively, if the multicast file transfer client 413 is installed on a separate server, then the hosts file should be updated to translate the FQDN of the VOD importer server 404 to the IP address of the separate server (see the discussion related to FIG. 5).

In view of these changes, the following flow could occur to deploy a VOD asset 414 from the SHO 302′ to the VHO 306′. This exemplary flow is illustrated in FIG. 4, which shows a first embodiment of the present invention where the software for the multicast file transfer clients 413a and 413b has been installed directly on the VOD servers 412a and 412b. In this example, a VOD asset 414 (e.g., VOD title) is sent from a post-production house and received at the VOD importer server 404 in the SHO 302′. The VOD importer server 404 places the VOD asset 414 in a staging volume 416 and applies encryption algorithms 418 (e.g., DRM keys 418) and makes custom metadata 420 modifications to the VOD asset 414. Once this is complete, the VOD asset 414 is ready for distribution to all of the VHOs 306 (only one has been shown). To accomplish this, the operator 422 accesses the third party multicast file transfer server 405 and chooses to download the files of the desired VOD asset 414 to all of the VOD servers 412a and 412b (step 1a). The multicast file transfer server 405 retrieves the metadata 420 and media files related to the VOD asset 414 from the staging volume/folder 416 in the VOD importer server 404 (step 1b). The multicast file transfer server 405 then multicasts over UDP the required files associated with the VOD asset 414 to all of the third party multicast file transfer clients 413a and 413b associated with the VOD servers 412a and 412b (step 1c) (note: the files could also be multicast at the same time to other VHOs 306′). If needed, the third party multicast file transfer clients 413a and 413b may request retransmissions for any packets lost during the transmission of the VOD asset 414. The VOD asset 414 is stored in the configured “staging” cache volume 415a and 415b in each of the VOD servers 412a and 412b (step 1d).

When the file transfer is complete, the operator 422 accesses the unicast IPTV middleware 421 in the branch management server 406 and chooses to deploy the VOD asset 414 (step 2a). In response, the branch management server 406 proxies the request to the branch controller 408 (step 2b). The branch controller 408 creates (step 2c) an HTTPS tunnel 424 to the VOD OSS/SMT server 402 which then proxies the request to the VOD importer server 404 to verify the status of the VOD asset 414 and retrieve the file location (steps 2d and 2e). The retrieved file location is an URI which contains the FQDN of the VOD importer server 404, such as “http://shovodimp01.sho.domain.com/Staging/asset1/asset_file1.rtp”. Upon receiving the URI of the VOD importer server 404, the branch controller 408 stores the results of this transaction within the branch database 410 and creates the deployment jobs for the VOD servers 412a and 412b (step 2f).

Thereafter, when the first VOD server 412a checks in with the branch controller 408 (step 3a), it is assigned its deployment job as listed in the branch database 410 (step 3b). The first VOD server 412a then uses the URI retrieved by the branch controller 408 to download (step 3c) the required files of the VOD asset 414 which where previously stored in its own configured “staging” cache volume 415a. This is possible since each VOD server 412a and 412b previously updated its host files (e.g., located in C:\WINDOWS\system32\drivers\etc\) to force the translation of the FQDN of the VOD importer server 404 to their respective VOD server's local IP address of 127.0.0.1 (for example) which is associated with the location of the multicast cache volumes 415a and 415b. Without the hosts entry, the FQDN would be translated by a DNS (not shown) at deployment time to the VOD importer server's 404 IP address, forcing the VOD server 412a to send a request during step 3c to the VOD importer server 404 in the SHO 302′. Instead, as a result of all of this, the VOD server 412a will locally retrieve (step 3c) the files of the VOD asset 414 via HTTP from the multicast cache volume 415a which is desirable because the VOD server 412a no longer needs to use the problematical HTTPS connection 230 (SSL tunnel) to retrieve the files directly from the VOD importer server 404 as was required in the prior art (compare FIGS. 2 and 4). This saves a large amount of bandwidth since the VOD server 412a no longer needs to directly contact the VOD importer server 404 during the deployment of the VOD assets 414. Finally, the VHO server 412a would store the retrieved files associated with the VOD asset 414 in the media share volume of the connected DAS device 428 (step 3d).

At this point, the branch controller 408 creates an HTTPS connection 430 to the VOD OSS/SMT server 402 in the SHO 302′ to retrieve the DRM keys 418 for the VOD asset 414 (step 4a). The VOD OSS/SMT server 402 proxies the request to the VOD importer server 404 which performs a proper transcription based on the branch certificate's public key and returns the DRM keys 418 (steps 4b and 4c). The branch controller 408 then stores the DRM keys 418 in the branch database 410 (step 4d). This transfer requires very low bandwidth. Thereafter, the remaining VOD server(s) 412b (only one shown) retrieves the VOD asset 414 from the first VOD server's DAS device 428. In particular, each remaining VOD server 412b retrieves their jobs from the branch controller 408 (step 5a), accesses the first VOD server's DAS device 428 via HTTP (steps 5b and 5c) and stores the metadata and media files associated with the VOD asset 414 on their local DAS device 428 (step 5d).

Referring to FIG. 5, there is a diagram illustrating the basic components within the enhanced SHO 302″ and the enhanced VHO 306″ shown in FIG. 3 in accordance with a second embodiment of the present invention. As shown, the enhanced SHO 302″ includes a VOD OSS/SMT server 402, a VOD importer server 404, and a third-party multicast file transfer server 405. The enhanced VHO 306″ includes a branch management server 406, a branch controller 408, a branch database 410, multiple VOD servers 412a and 412b (two shown), a third-party multicast file transfer client 413c, and a dedicated server 417 (compare to FIG. 4). The IPTV servers 402, 404, 406, 408, 412a and 412b, and 417 are configured as discussed above with respect to the first embodiment so as to allow the multicast transfer of the VOD asset 414 to operate transparently to the unicast IPTV middleware 421. An exemplary flow is illustrated in FIG. 5, which shows a second embodiment of the present invention being implemented when the software for the multicast file transfer client 413 has been installed on the dedicated server 417.

In this IPTV architecture, a VOD asset 414 (e.g., VOD title) is sent from a post-production house and received at the VOD importer server 404 in the SHO 302″. The VOD importer server 404 places the VOD asset 414 in a staging volume 416 and applies encryption algorithms 418 (e.g., DRM keys 418) and makes custom metadata 420 modifications to the VOD asset 414. Once this is complete, the VOD asset 414 is ready for distribution to all of the VHOs 306″ (only one has been shown). To accomplish this, the operator 422 accesses the third party multicast file transfer server 405 and chooses to download the files of the desired VOD asset 414 to the dedicated server 417 in the VHO 306″ (step 1a). The multicast file transfer server 405 retrieves the metadata 420 and media files related to the VOD asset 414 from the staging volume/folder 416 in the VOD importer server 404 (step 1b). The multicast file transfer server 405 then multicasts over UDP the required files associated with the VOD asset 414 to the multicast file transfer client 413c which is associated with the dedicated server 417 (step 1c) (note: the files could also be multicast at the same time to other VHOs 306″). If needed, the third party multicast file transfer client 413c may request retransmissions for any packets lost during the transmission of the VOD asset 414. The VOD asset 414 is stored in the configured “staging” cache volume 415c in dedicated server 417 (step 1d).

When the file transfer is complete, the operator 422 accesses the unicast IPTV middleware 421 in the branch management server 406 and chooses to deploy the VOD asset 414 (step 2a). In response, the branch management server 406 proxies the request to the branch controller 408 (step 2b). The branch controller 408 creates (step 2c) an HTTPS tunnel 424 to the VOD OSS/SMT server 402 which then proxies the request to the VOD importer server 404 to verify the status of the VOD asset 414 and retrieve the file location (steps 2d and 2e). The retrieved file location is an URI which contains the FQDN of the VOD importer server 404, such as “http://shovodimp01.sho.domain.com/Staging/asset1/asset_file1.rtp”. Upon receiving the URI of the VOD importer server 404, the branch controller 408 stores the results of this transaction within the branch database 410 and creates the deployment jobs for the VOD servers 412a and 412b (step 2f).

Thereafter, when the first VOD server 412a checks in with the branch controller 408 (step 3a), it is assigned its deployment job as listed in the branch database 410 (step 3b). The first VOD server 412a then uses the URI retrieved by the branch controller 408 to download (step 3c) the required files of the VOD asset 414 which where previously stored in the dedicated server's configured “staging” cache volume 415c. This is possible since each VOD server 412a and 412b previously updated its host files (e.g., located in C:\WINDOWS\system32\drivers\etc\) by translating the FQDN of the VOD importer server 404 to the dedicated server's local IP address 10.1.1.10 (for example) which is associated with the location of the multicast cache volume 415c. Without the hosts entry, the FQDN would be translated by a DNS (not shown) at deployment time to the VOD importer server's 404 IP address, forcing the VOD server 412a to send a request during step 3c to the VOD importer server 404 in the SHO 302′. Instead, as a result of all of this, the VOD server 412a will retrieve (step 3c) the files of the VOD asset 414 via HTTP from the dedicated server 417 which is desirable because the VOD server 412a no longer needs to use the problematical HTTPS connection 230 (SSL tunnel) to retrieve the files directly from the VOD importer server 404 as was required in the prior art (compare FIGS. 2 and 5). This saves a large amount of bandwidth since the VOD server 412a no longer needs to directly contact the VOD importer server 404 during the deployment of the VOD assets 414. Finally, the VHO server 412a would store the retrieved files associated with the VOD asset 414 in the media volume in the connected DAS device 428 (step 3d).

At this point, the branch controller 408 creates an HTTPS connection 430 to the VOD OSS/SMT server 402 in the SHO 302″ to retrieve the DRM keys 418 for the VOD asset 414 (step 4a). The VOD OSS/SMT server 402 proxies the request to the VOD importer server 404 which performs a proper transcription based on the branch certificate's public key and returns the DRM keys 418 (steps 4b and 4c). The branch controller 408 then stores the DRM keys 418 in the branch database 410 (step 4d). This transfer requires very low bandwidth. Thereafter, the remaining VOD server(s) 412b (only one shown) retrieves the VOD asset 414 from the first VOD server's DAS device 428. In particular, each remaining VOD server 412b retrieves their jobs from the branch controller 408 (step 5a), accesses the first VOD server's DAS device 428 via HTTP (steps 5b and 5c) and stores the metadata and media files associated with the VOD asset 414 on their local DAS device 428 (step 5d).

In the second embodiment, the multicast file transfer client 414c is installed directly on the dedicated server 417 instead of the VOD servers 412a and 412b which is desirable since the multicast file transfer client 414c and cache 415c would be installed on a smaller subset of servers within each VHO 306″. In this scheme, a smaller set of servers 417 receive the multicast transfer of the VOD asset 414 which decreases the local load of multicast traffic. Plus, this scheme reduces the number of unused copies of the VOD assets 414 in the VHO 306″. Lastly, in this scheme, measures could be taken to provide fault tolerance such that if one dedicated server 417 hosting the multicast file transfer had a failure then an alternate server hosting the same information could be made available. For example, possibilities include multiple entries in the VOD server's hosts file coupled with a monitoring script to detect communication failures to the dedicated server 417.

Referring to both embodiments, if the multicast file transfer product 405, 413a, 413b and 413c offers an API which exposes an interface for file transfer and receiver status, further integration benefits could be realized. For instance, a tool could be created which would first interface with the multicast file transfer API to push the files of the VOD asset 414 into the VHOs 306. When the receivers (VOD servers 412a and 412b, dedicated server 417) report a successful transfer (via an API query or callback), the tool could then interface with the unicast IPTV middleware's API to perform the VOD deployment. Creating such a tool would minimize the amount of manual work for the operator 422 and allow scheduling of VOD deployments during off-peak hours.

From the foregoing, it should be appreciated that operators of major IPTV middleware solutions can use the present invention to seamlessly integrate a bandwidth-efficient delivery mechanism for VOD assets to their regional sites. The bandwidth required for VOD deployment would be decreased from a function of the number of sites to a single UDP stream per deployment. Thus, the entire network can scale with minimal impact to the VOD deployment process. VOD deployment times would improve dramatically with the increased bandwidth, allowing the operator to keep pace with the current VOD ingestion rate and offer a more appealing VOD lineup to the end-users. This should directly improve the operator's revenue and operating expenses.

Although two embodiments of the present invention have been illustrated in the accompanying Drawings and described in the foregoing Detailed Description, it should be understood that the present invention is not limited to the disclosed embodiments, but is capable of numerous rearrangements, modifications and substitutions without departing from the invention as set forth and defined by the following claims.

1. A method for transferring a Video-On-Demand (VOD) asset from a Super Headend Office (SHO) to a Video Head Office (VHO) both of which are part of an Internet Protocol Television (IPTV) network, said method comprising the steps of:
using a multicast file transfer server associated with said SHO to multicast the VOD asset to one or more multicast file transfer clients in said VHO;
storing the VOD asset received by the one or more multicast file transfer clients within one or more multicast caches in said VHO;
accessing a unicast IPTV middleware in said VHO to initiate deployment of the VOD asset from the one or more multicast caches to one or more VOD servers within said VHO;
deploying the VOD asset using a HyperText Transfer Protocol (HTTP) connection from one multicast cache to the first VOD server within said VHO; and
instructing each of the remaining VOD servers if any within said VHO to retrieve the VOD asset from the first VOD server.

2. The method of claim 1, wherein said one or more multicast caches are associated with a dedicated server or the one or more VOD servers.

3. The method of claim 1, wherein said using step further includes the steps of:
retrieving the VOD asset from a staging volume in a VOD importer server; and
multicasting the VOD asset via User Datagram Protocol (UDP) to the one or more multicast file transfer clients in said VHO.

4. The method of claim 1, wherein said accessing step further includes the steps of:
enabling a branch management server associated with the unicast IPTV middleware to proxy a request to a branch controller associated with said VHO;
creating a HyperText Transfer Protocol Secure (HTTPS) connection between the branch controller and a VOD Operations Support System/Service Management Tool (OSS/SMT) server associated with said SHO;
forwarding the proxy request from the branch controller via the VOD OSS/SMT to a VOD importer server associated with said SHO;
receiving a file location at the branch controller from the VOD importer server, where the file location is a Uniform Resource Indicator (URI) that contains a Fully-Qualified Domain Name (FQDN) of the VOD importer server;
storing the file location in a branch database associated with said VHO; and
creating deployment jobs at the branch controller for the one or more VOD servers.

5. The method of claim 1, wherein said deploying step further includes the steps of:
assigning the first VOD server a deployment job;
enabling the first VOD server to use a file location associated with the VOD asset to retrieve the VOD asset via a HTTP connection from the one multicast cache, where the file location is a Uniform Resource Indicator (URI) which previously had a Fully-Qualified Domain Name (FQDN) associated with a VOD importer server within said SHO but the FQDN was translated to an Internet Protocol (IP) address associated with the one multicast cache that is associated with a dedicated server or the first VOD server; and
storing the VOD asset in a Direct Attached Storage (DAS) device associated with the first VOD server.

6. The method of claim 1, wherein said instructing step further includes the steps of:
retrieving a deployment job assignment for each remaining VOD server from the branch controller;
enabling each remaining VOD server to access the first VOD server and retrieve via a HyperText Transfer Protocol (HTTP) connection the VOD asset; and
storing the retrieved VOD asset in a Direct Attached Storage (DAS) device associated with each remaining VOD server.

7. The method of claim 1, further comprising the step of retrieving a Digital Rights Management (DRM) key of the VOD asset from a VOD importer server associated with said SHO in response to a proxy request from a branch controller associated with said VHO.

8. The method of claim 7, wherein said retrieving step further includes the steps of:
creating a HyperText Transfer Protocol Secure (HTTPS) connection between the branch controller and a VOD Operations Support System/Service Management Tool (OSS/SMT) server associated with said SHO;
forwarding the proxy request from the branch controller via the VOD OSS/SMT to the VOD importer server associated with said SHO;
receiving the DRM key at the branch controller from the VOD importer server; and
storing the DRM key in a branch database associated with said VHO.

9. The method of claim 1, wherein each multicast file transfer client if needed requests the multicast file transfer server to re-transmit loss packets associated with the VOD asset.

10. An Internet Protocol Television (IPTV) network comprising:
a Super Headend Office (SHO); and
a Video Head Office (VHO);
said SHO including a multicast file transfer server that multicast a Video-On-Demand (VOD) asset to one or more multicast file transfer clients in said VHO;
said VHO including one or more multicast caches that store the VOD asset received by the one or more multicast file transfer clients;
said VHO including a branch management server with unicast IPTV middleware that initiates deployment of the VOD asset from the one or more multicast caches to one or more VOD servers in said VHO;
said VHO including a branch controller that uses a HyperText Transfer Protocol (HTTP) connection to deploy the VOD asset from one multicast cache to the first VOD server; and
said VHO including the branch controller that instructs each of the remaining VOD servers if any to retrieve the VOD asset from the first VOD server.

11. The IPTV network of claim 10, wherein said multicast file transfer server multicasts the VOD asset to the one or more multicast file transfer clients by:
retrieving the VOD asset from a staging volume in a VOD importer server in said SHO; and
multicasting the VOD asset via User Datagram Protocol (UDP) to the one or more multicast file transfer clients in said VHO.

12. The IPTV network of claim 10, wherein said branch management server with the unicast IPTV middleware initiates deployment of the VOD asset from the one or more multicast caches the one or more VOD servers by sending a request to a branch controller associated with said VHO, wherein said branch controller then:
creates a HyperText Transfer Protocol Secure (HTTPS) connection with a VOD Operations Support System/Service Management Tool (OSS/SMT) server associated with said SHO;
forwards the proxy request through the VOD OSS/SMT to a VOD importer server associated with said SHO;
receives a file location from the VOD importer server, where the file location is a Uniform Resource Indicator (URI) that contains a Fully-Qualified Domain Name (FQDN) of the VOD importer server;
stores the file location in a branch database associated with said VHO; and
creates deployment jobs for the one or more VOD servers.

13. The IPTV network of claim 10, wherein said branch controller uses the HTTP connection to deploy the VOD asset from one multicast cache to the first VOD server by assigning a deployment job to the first VOD server, where the first VOD server then:
uses a file location associated with the VOD asset to retrieve the VOD asset via a HTTP connection from the one multicast cache, where the file location is a Uniform Resource Indicator (URI) which previously had a Fully-Qualified Domain Name (FQDN) associated with a VOD importer server within said SHO but the FQDN was translated to an Internet Protocol (IP) address associated with the one multicast cache that is associated with a dedicated server or the first VOD server; and
stores the VOD asset in a Direct Attached Storage (DAS) device.

14. The IPTV network of claim 10, wherein said branch controller instructs each of the remaining VOD servers if any to retrieve the VOD asset from the first VOD server by assigning a deployment job to each of the remaining VOD servers, where each remaining VOD server then:
accesses the first VOD server;
retrieves the VOD asset via a HyperText Transfer Protocol (HTTP) connection from the first VOD server; and
stores the retrieved VOD asset in a Direct Attached Storage (DAS) device.

15. The IPTV network of claim 10, wherein said branch controller further retrieves a Digital Rights Management (DRM) key of the VOD asset from a VOD importer server associated with said SHO.

16. The IPTV network of claim 15, wherein said branch controller retrieves the DRM key by:
creating a HyperText Transfer Protocol Secure (HTTPS) connection with a VOD Operations Support System/Service Management Tool (OSS/SMT) server associated with said SHO;
forwarding a proxy request through the VOD OSS/SMT to a VOD importer server associated with said SHO;
receiving the DRM key from the VOD importer server; and
storing the DRM key in a branch database associated with said VHO.

17. The IPTV network of claim 10, wherein said each multicast file transfer client if needed requests the multicast file transfer server to re-transmit loss packets associated with the VOD asset.

18. A method for transferring a Video-On-Demand (VOD) asset from a Super Headend Office (SHO) to a Video Head Office (VHO) both of which are part of an Internet Protocol Television (IPTV) network, said method comprising the steps of:
(A) using a multicast file transfer server associated with said SHO to multicast the VOD asset to one or more multicast file transfer clients in said VHO, wherein said using step further includes the steps of:
(i) retrieving the VOD asset from a staging volume in a VOD importer server;
(ii) multicasting the VOD asset via User Datagram Protocol (UDP) to the one or more multicast file transfer clients in said VHO; and
(B) storing the VOD asset received by the one or more multicast file transfer clients within one or more multicast caches in said VHO
(C) accessing a branch management server with unicast IPTV middleware in said VHO to initiate deployment of the VOD asset from the one or more multicast caches to one or more VOD servers within said VHO wherein said accessing step further includes the steps of:
(i) enabling the branch management server associated with the unicast IPTV middleware to proxy a request to a branch controller associated with said VHO;
(ii) creating a HyperText Transfer Protocol Secure (HTTPS) connection between the branch controller and a VOD Operations Support System/Service Management Tool (OSS/SMT) server associated with said SHO;
(iii) forwarding the proxy request from the branch controller via the VOD OSS/SMT to the VOD importer server associated with said SHO;
(iv) receiving a file location at the branch controller from the VOD importer server, where the file location is a Uniform Resource Indicator (URI) that contains a Fully-Qualified Domain Name (FQDN) of the VOD importer server;
(v) storing the file location in a branch database associated with said VHO; and
(vi) creating deployment jobs at the branch controller for the one or more VOD servers
(D) deploying the VOD asset using a HyperText Transfer Protocol (HTTP) connection from one multicast cache to the first VOD server within said VHO, wherein said deploying step further includes the steps of:
(i) assigning the first VOD server a deployment job;
(ii) enabling the first VOD server to use a file location associated with the VOD asset to retrieve the VOD asset via a HTTP connection from the one multicast cache, where the file location is a Uniform Resource Indicator (URI) which previously had a Fully-Qualified Domain Name (FQDN) associated with a VOD importer server within said SHO but the FQDN was translated to an Internet Protocol (IP) address associated with the one multicast cache that is associated with a dedicated server or the first VOD server; and
(iii) storing the VOD asset in a Direct Attached Storage (DAS) device associated with the first VOD server; and
(E) instructing each of the remaining VOD servers if any within said VHO to retrieve the VOD asset from the first VOD server, wherein said instructing step further includes the steps of:
(i) retrieving a deployment job assignment for each remaining VOD server from the branch controller;
(ii) enabling each remaining VOD server to access the first VOD server and retrieve via a HyperText Transfer Protocol (HTTP) connection the VOD asset; and
(iii) storing the retrieved VOD asset in a Direct Attached Storage (DAS) device associated with each remaining VOD server.

19. The method of claim 18, further comprising the step of retrieving a Digital Rights Management (DRM) key of the VOD asset from the VOD importer server in response to a proxy request from the branch controller, wherein said retrieving step further includes the steps of:
creating a HyperText Transfer Protocol Secure (HTTPS) connection between the branch controller and the VOD Operations Support System/Service Management Tool (OSS/SMT) server associated with said SHO;
forwarding the proxy request from the branch controller via the VOD OSS/SMT to the VOD importer server associated with said SHO;
receiving the DRM key at the branch controller from the VOD importer server; and
storing the DRM key in a branch database associated with said VHO.

20. The method of claim 18, wherein said each multicast file transfer client if needed requests the multicast file transfer server to re-transmit loss packets associated with the VOD asset.
